(19) United States
(12) Patent Application Publication
(10) Pub. No.: US 2024/0124812 A1
(43) Pub. Date: Apr. 18, 2024

(54) COCKTAIL SMOKER

(71) Applicant: Hunter Jackson Enterprises, L.L.C., Shelbyville, KY (US)

(72) Inventors: Susan Jackson, Shelbyville, KY (US); Daniel Jackson, Shelbyville, KY (US)

(21) Appl. No.: 18/380,000

(22) Filed: Oct. 13, 2023

Related U.S. Application Data
(60) Provisional application No. 63/415,727, filed on Oct. 13, 2022.

(51) Int. Cl. C12G 3/07; A23B 4/052

(52) U.S. Cl. CPC C12G 3/07; A23B 4/052

(57) ABSTRACT

A smoker for imparting a flavor to a beverage is described. The smoker includes a support configured and dimensioned to be supported atop a lip or rim of a beverage glass, the support including a through-bore defined therethrough. A plug is provided, configured and dimensioned to be retained within the through-bore. The plug includes a recess defined within an interior of the plug and at least one outlet defined within the at least one plug side wall whereby an interior of the recess is placed in fluid communication with an exterior of the plug. Methods for use of the described smoker for imparting a flavor to a beverage are described.

### TECHNICAL FIELD

The presently-disclosed subject matter generally relates to the smokers for use in infusing/flavoring beverages.

### BACKGROUND

“Smoking” as used in the beverage industry is a technique for adding flavors/smoky notes to cocktails by exposing the entire cocktail, individual components, or only the drinking glass to smoke derived from a flavorant of choice. A cocktail smoker functions because moisture quickly condenses on cold surfaces, for example the cold moisture-covered sides of a glass, the film of water that forms on an ice cube, etc. The components of smoke except carbon particles and tar dissolve in the moisture, contributing to the flavor, appearance, and texture of a beverage such as a cocktail. In particular, because the sense of taste is heavily influenced by the sense of smell, increasing the aroma of beverages greatly contributes to the taste of the beverages.

Disclosed herein is a design for a cocktail smoker that advantageously does not require multiple components such as mesh surfaces for holding a flavorant such as wood chips/shavings, a smoke gun, or the like.

### SUMMARY

In accordance with the purposes and benefits described herein, in one aspect of the present disclosure a smoker for imparting a flavor to a beverage is described. The smoker includes a support configured and dimensioned to be supported atop a lip or rim of a beverage glass, with the support including a through-bore defined therethrough. A plug is provided also, configured and dimensioned to be retained within the through-bore.

In embodiments, the plug includes a recess defined within an interior of the plug. The recess includes at least one side wall and at least one outlet defined within the at least one plug side wall. The plug recess is open at a first end and is sealed at a second, opposite end to define a receptacle for holding one or more flavorant substances or materials, the receptacle ending in a burn surface adapted for burning the one or more flavorant substances or materials.

By the at least one outlet, an interior of the recess is placed in fluid communication with an exterior of the plug. In embodiments, the plug is configured and dimensioned to be retained within the through-bore to define a substantially airtight seal whereby the at least one outlet is held below a bottom surface of the support. In embodiments, the recess defines a cross-sectional shape selected from the group consisting of a circle, a square, a rectangle, a hexagon, and an octagon.

In another aspect of the disclosure, a method for flavoring a beverage is described. A smoker as described above is provided, positioned atop a rim or lip of a suitable beverage glass. One or more flavorant substances or materials are placed within an interior of the recess and ignited whereby a smoke emitted therefrom passes from an interior of the recess to an exterior of the plug to contact one or more of a surface of a beverage contained within the beverage glass and an interior surface of the beverage glass. The one or more flavorant substances or materials may be ignited by any suitable means, including without intending any limitation use of a suitable torch such as a pastry torch.

In the following description, there are shown and described several preferred embodiments of a smoker for imparting a flavor to a beverage, and related methods. As it should be realized, the devices and methods are capable of other, different embodiments and their several details are capable of modification in various, obvious aspects all without departing from the methods and devices as set forth and described in the following claims. Accordingly, the drawings and descriptions should be regarded as illustrative in nature and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are used, and the accompanying drawings of which:

FIG. 1 is a side view of a cocktail smoker according to the present disclosure.

FIG. 2 is a top view of an embodiment of a support for the cocktail smoker of FIG. 1.

FIG. 3 is a side view of a plug for the cocktail smoker of FIG. 1.

Reference will now be made in detail to the present preferred embodiments of the smoker for imparting a flavor to a beverage and related methods, examples of which are illustrated in the accompanying drawing figures, wherein like numerals are used to represent like elements.

### DETAILED DESCRIPTION

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

It will be appreciated that for simplicity and clarity of illustration, where appropriate, reference numerals are repeated among the various figures to indicate corresponding, identical, or analogous features. Numerous specific details are set forth in order to provide a thorough understanding of the embodiments described herein. However, those of ordinary skill in the art will understand that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

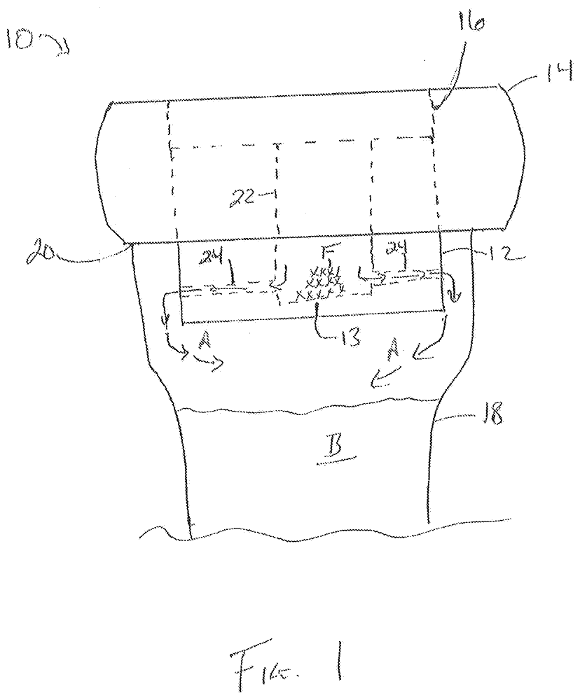

In one embodiment as shown in FIG. 1, a cocktail smoker 10 according to the present disclosure comprises a plug 12 and a support 14 including a through-bore 16 (see also FIG. 3). Through-bore 16 is dimensioned to hold the plug 12 snugly but releasably therewithin to form a substantially airtight seal. Plug 12 may be releasably held within through-bore 16 by any suitable means, including without intending any limitation a press-fit, friction fit, interference fit, with assistance of a mild adhesive, and other known methods. As will be appreciated, this allows easy removal of plug 12 for cleaning, replacement, repair, etc.

As shown in FIG. 1, the support 14 will preferably be dimensioned to have a cross-sectional width dimension forming a lip suitable for conveniently resting the cocktail smoker 10 atop a beverage glass 18 rim 20 whereby a portion of the plug 12 is held within an interior of the beverage glass. It will be appreciated that support 14 may be any suitable or desired shape, such as a circle, a square, a hexagon, an octagon, and others.

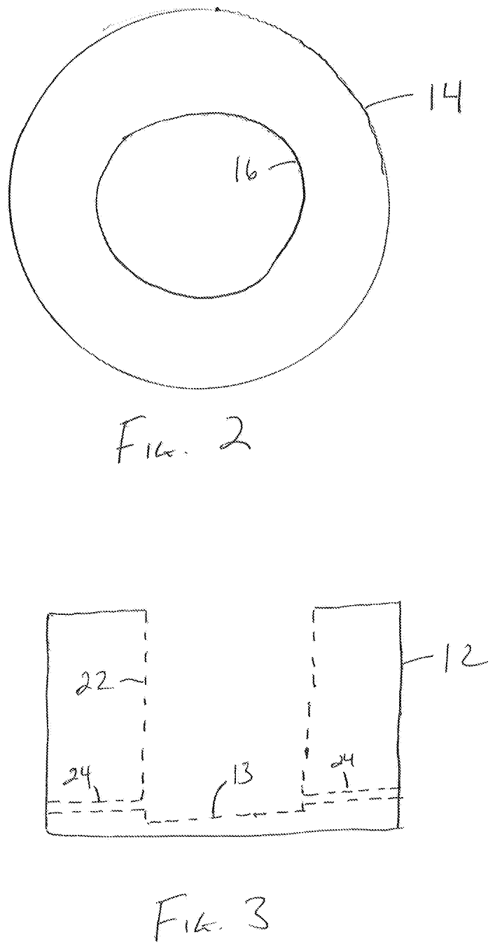

With reference also to FIG. 2, the plug 12 includes a recess 22 defining an inlet ending in a burn surface 23 as well as at least one outlet 24 placing an interior of recess 22 in fluid communication with an exterior of plug 12, thereby defining a channel for smoke to exit recess 22 and enter the interior of, for example, beverage glass 18 (see FIG. 1). Recess 22 includes at least one side wall and may be defined to have any desired cross-sectional dimension and shape, including without any limitation a cylinder, a square, a rectangle, a hexagon, an octagon, and others.

As will be appreciated, wood chips, shavings, or other ignitable substances suitable for imparting flavor to a beverage via smoke (generally designated as flavorants F) are placed within recess 22 and on burn surface 23 and ignited by any suitable means such as, without intending any limitation, a kitchen or pastry torch, a match, and others (not shown). The smoke emitted from ignited flavorants F exits the recess 22 via outlet 24 (see arrows A), impelled by one or both of gravity and the impetus from the flame of the torch to contact an interior surface of glass 18 as well as a surface of a beverage B contained therein. As described, this smoke provides visual, aromatic, and sensory (taste) enhancements to the beverage B.

It will be appreciated that plug 12 and support 14 may be fabricated of any desired and suitable material. In an embodiment, plug 12 and support 14 are fabricated of materials sourced from barrels used to age alcoholic beverages such as whiskey. For example plug 12 and support 14 may be fabricated of materials sourced from bourbon barrels, which are as is known typically barrels manufactured of white oak and pre-charred in the interior prior to addition of bourbon for aging, which charring adds a distinctive flavoring to the beverage aged therein. Bourbon barrels are by tradition used only once and then discarded. In one embodiment, support 14 is fabricated from the head of a bourbon or other whisky barrel, and plug 12 is fabricated from the bung of a bourbon or other barrel.

In this embodiment, support 14 is cut to a desired predetermined width dimension from a the material of a barrel head and planed to a desired predetermined thickness. Through-bore 16 is defined through support 14 by any suitable method, such as drilling to a particular width diameter, cutting with a jigsaw, etc. In one embodiment, the width diameter is slightly less than the width diameter of a barrel bung used to fabricate plug 12. As is known, bourbon barrel bungs are typically fabricated of poplar, and as will be appreciated use of these materials, which are also pre-charred on at least one surface due to their prior use as described above, adds further flavors and flavor notes to the smoke generated therein in accordance with the nature of the distilled product previously aged in the barrel.

Plug 12 may be formed from a barrel bung that is otherwise not altered as to exterior dimensions, or may be fabricated from a different material that is sized to form the above-described fits within through-bore 16. Recess 22 is defined in an interior of plug 12, such as by drilling, sawing, chiseling, or other suitable methods. At least one outlet 24 is defined within plug 12, such as by drilling or other suitable methods, to provide a fluid connection between an interior of recess 22 and an exterior of plug 12, for the reasons described above.

In one specific embodiment intended for use in a conventional cocktail glass such as an old fashioned glass or tumbler, the support 14 is cut from a bourbon or other whisky barrel to a 3% inch diameter and planed. Through-bore 16 is defined by drilling a 1⅞ inch channel through the cut support 14. A 2 inch bung, also derived from a bourbon or other whiskey barrel, is used as the plug 12. A ¾ inch recess 22 is drilled along a longitudinal axis of plug 12, whereby recess 22 is provided a bottom burn surface 23 on which naturally or artificially flavored wood shavings, chips, or sawdust (flavorants F, see FIG. 1) may be placed.

One or more outlets 24 providing fluid communication between an interior of recess 22 and an exterior of plug 12 are then provided, such as by drilling a hole extending from an exterior side surface of plug 12 to an interior of recess 22. By the relative cross-sectional dimensions of the plug 12 and the support 14 through-bore 16, a snug and substantially airtight seal is achieved when plug 12 is positioned within through-bore 16, with outlets 24 being positioned below a bottom surface of support 14 (and within an interior of a beverage glass G but above a top surface of a beverage B contained by glass G) as described above and as shown in FIG. 1.

Flavorants F may then be ignited, such as by a kitchen or pastry torch (not shown). During the burning process, smoke is released. One or both of gravity and the impetus of the flame of the pastry torch force the smoke from flavorants F from the interior of recess 22 to the interior of beverage glass G, where the smoke contacts one or more of the surface of beverage B, the sides of glass G, etc. The flavor imparted by this smoke, as well as the visual aspect of smoke on or in the beverage glass G, then contribute to the sensory experience of a consumer enjoying the beverage B.

The disclosed cocktail smoker 10 may be provided as an assembled unit, as individual components including one or more replacement pieces, or in kit form accompanied by, optionally, one or more of a torch or other flame source, one or more sources of wood chips or shavings for imparting flavor to a beverage by smoking, glassware, and other accessories.

Although any methods, devices, and materials similar or equivalent to those described herein can be used in the practice or testing of the presently-disclosed subject matter, representative methods, devices, and materials are described herein. For example, one or more components of the described cocktail smoker 10 may be fabricated by different methods and of other materials, such as without including any limitation molding or machining from plastics, polymers, resins, metals, and other materials.

Following long-standing patent law convention, the terms “a”, “an”, and “the” refer to “one or more” when used in this application, including the claims. As used herein, “optional” or “optionally” means that the subsequently described event or circumstance does or does not occur and that the description includes instances where said event or circumstance occurs and instances where it does not.

It will be understood that various details of the presently disclosed subject matter can be changed without departing from the scope of the subject matter disclosed herein. Furthermore, the foregoing description is for the purpose of illustration only, and not for the purpose of limitation. Obvious modifications and variations are possible in light of the above teachings. All such modifications and variations are within the scope of the appended claims when interpreted in accordance with the breadth to which they are fairly, legally and equitably entitled.

What is claimed:

1. A smoker for imparting a flavor to a beverage, comprising:
a support configured and dimensioned to be supported atop a lip or rim of a beverage glass, the support including a through-bore defined therethrough; and
a plug configured and dimensioned to be retained within the through-bore.

2. The smoker of claim 1, wherein the plug includes:
a recess defined within an interior of the plug, the recess including at least one side wall; and
at least one outlet defined within the at least one plug side wall whereby an interior of the recess is placed in fluid communication with an exterior of the plug.

3. The smoker of claim 2, wherein the plug is configured and dimensioned to be retained within the through-bore to define a substantially airtight seal whereby the at least one outlet is held below a bottom surface of the support.

4. The smoker of claim 2, wherein the recess defines a cross-sectional shape selected from the group consisting of a circle, a square, a rectangle, a hexagon, and an octagon.

5. The smoker of claim 2, wherein the recess is open at a first end and is sealed at a second, opposite end to define a receptacle for holding one or more flavorant substances or materials, the receptacle ending in a burn surface adapted for burning the one or more flavorant substances or materials.

6. A method for flavoring a beverage, comprising:
providing a smoker comprising:
a support configured and dimensioned to be supported atop a lip or rim of a beverage glass, the support including a through-bore defined therethrough; and
a plug configured and dimensioned to be retained within the through-bore, the plug including a recess having at least one side wall defined within an interior thereof and at least one outlet defined within the at least one side wall whereby an interior of the recess is placed in fluid communication with an exterior of the plug;
placing the smoker atop a rim or lip of a suitable beverage glass;
placing one or more flavorant substances or materials within an interior of the recess; and
igniting the one or more flavorant substances or materials whereby a smoke emitted therefrom passes from an interior of the recess to an exterior of the plug to contact one or more of a surface of a beverage contained within the beverage glass and an interior surface of the beverage glass.

7. The method of claim 6, wherein the plug is configured and dimensioned to be retained within the through-bore to define a substantially airtight seal whereby the at least one outlet is held below a bottom surface of the support.

8. The method of claim 6, wherein the recess defines a cross-sectional shape selected from the group consisting of a circle, a square, a rectangle, a hexagon, and an octagon.

9. The method of claim 6, wherein the recess is open at a first end and is sealed at a second, opposite end to define a receptacle for holding the one or more flavorant substances or materials;
further wherein the receptacle ends in a burn surface adapted for burning the one or more flavorant substances or materials.

10. The method of claim 6, wherein the one or more flavorant substances or materials are ignited by use of a torch.
